(19) United States
(12) Patent Application Publication
(10) Pub. No.: US 2026/0110622 A1
(43) Pub. Date: Apr. 23, 2026

(54) DRAG FORCE INDICATOR

(71) Applicant: UNITED STATES GYPSUM COMPANY, Chicago, IL (US)

(72) Inventors: Nora Kathleen LEONARD, St. Charles, IL (US); David Daniel PELOT, Chicago, IL (US)

(21) Appl. No.: 19/170,801

(22) Filed: Apr. 4, 2025

Related U.S. Application Data
(60) Provisional application No. 63/709,889, filed on Oct. 21, 2024.

(51) Int. Cl. G01N 19/04; C04B 14/18; C04B 14/26; C04B 111/00

(52) U.S. Cl. CPC G01N 19/04; C04B 14/18; C04B 14/26; C04B 2111/00689; C04B 2201/00

(57) ABSTRACT

An apparatus for determining durability of a wallboard joint compound composition includes an adhesion release testing machine including a machine base, a vertical mast connected to the base, a load cell connected to the mast, a sled movable on the machine base between a first position and a second position, a display associated with the machine base and connected to the load cell for displaying numerical values of loads applied to the load cell. A probe plate includes a lower surface with a depending probe; an anchor base disposed on an upper surface of the probe plate; and a chain connecting the probe plate to the load cell. A set sample strip of wallboard joint compound composition is secured to an upper surface of the sled and arranged for engagement by the probe as the sled moves on the machine based between the first position and the second position.

### RELATED APPLICATION

The present application is a Non-Provisional of, and claims 35 U.S.C. 119 priority from, U.S. Provisional Application Ser. No. 63/709,889 filed Oct. 21, 2024, the entire contents of which are incorporated by reference herein.

### BACKGROUND

The present invention relates generally to the design and production of wallboard joint compounds, plaster and the like.

Conventional wallboard joint compounds are used for filling seams between adjacent wallboard panels used to form walls or ceilings. Such compounds are settable upon application to the seam, and are provided in powder format, which is mixed with water at the jobsite, or in premixed format packaged for use from the container.

There are several categories of joint compounds. Drying type compounds harden through the evaporation of water, whereas setting type joint compounds chemically react with water during the curing process. Setting type joint compounds typically use calcium sulfate hemihydrate, also known as stucco or plaster of Paris, as a base. When water is added to the setting type powder, it reacts with the calcium sulfate hemihydrate via a hydration reaction to form an interlocking matrix of calcium sulfate dihydrate crystals. The interlocking crystal matrix gives the compound increased strength. The benefit of a setting type joint compound over a drying type is the overall strength of the finished joint, resulting in less shrinking and cracking, as well as an independence from having to wait for the joint compound to be completely dry prior to further finishing. Drying type joint compounds have the advantage of ease of use, as they typically come in a ready mixed form, with water being added and mixed by the manufacturer. A third type of joint compound combines the setting action of a calcium sulfate hemihydrate-based compound with the ease of use of a ready mixed compound.

Ready mixed joint compound is typically supplied to the customer in either cardboard cartons or plastic pails in units having volumes of 1 quart (0.95 L.), 1 gallon (3.78 L.) and 3.5 to 4.5 gallons (13.25-17.03 L). Joint compound is supplied at a viscosity typically higher than what is applied at the jobsite. This allows the contractor to mix in additional water using a power drill and mixing paddle to achieve the desired application viscosity.

Customers of joint compound are requesting a more durable, lightweight joint compound that does not scratch or dent as easily once set, but that remains relatively soft to allow sanding. Conventional evaluation of joint compounds for post-set durability involves sanding the finished composition and measuring the amount of material collected during sanding. This procedure is time-consuming and lacks sufficient accuracy. As such, the procedure is of limited value to joint compound designers and formulators.

Accordingly, there is a need for an improved procedure for evaluation of wallboard joint compound durability which addresses the drawbacks of the present system.

### SUMMARY

The above-listed need is met or exceeded by the present test method and apparatus which measures the force of a depending, pin-like probe to be dragged across a set joint compound sample. A more durable wallboard joint compound composition will generate less resistance to the movement of the probe being dragged across the sample, thus providing an indicator of durability. In other words, a measure of durability is the ability for the tested surface structure to remain intact by resisting scratches, dents fracture or damage to the surface, also referred to as physical interruption of the surface.

In contrast, a less durable composition will experience the probe creating a scratch or groove across the surface. A feature of the present method is that it measures a unique joint compound property, specifically related to scratch resistance, as opposed to a conventional sanding measurement, which measures the amount of material removed from the sample.

In the present test method, the amount of force needed to pull a probe across an upper surface of a set sample of joint compound is measured. The amount of pulling or drag force is measured in terms of pull/resistance, in optional combination with a weight placed upon the probe.

In the present test, a depending, pin-like probe or “pseudo fingernail” is dragged along a surface of set or dried wallboard joint compound and is connected to sensors which measure the resistance to pulling. A test sled or test platform carrying the sample of set joint compound composition is pulled at a consistent velocity from a first position to a second position. The probe is preferably connected to an anchor base, which in turn is attached via a chain or other connector to a load cell configured for measuring load resistance. Thus, as the test sled is moved from the first position to the second position, the load cell measures the resistance or load on the probe that is dragged across the test surface during movement of the test sled. A meter connected to the load cell displays the respective load force on the probe, which is seen as a reflection of the durability of the wallboard joint compound composition.

Another feature of the present system is that tests conducted on the present apparatus have shown that wallboard joint compound compositions having higher weight percentages of latex are more durable. In an embodiment, wallboard joint compound compositions including latex in wt. % ranging from 2.9 to 9.4% achieved an increase in durability from 0.613 to 0.435 compared to a control, with the lower number indicating less load on the probe and reflecting greater durability. Referring to Tables 1˜4 below, the durability values are obtained from a ratio of grams of drag force of the test samples with latex to the control samples lacking latex (732/1194=0.613; 520/1194=0.435.) In other words, wallboard joint compound compositions having enhanced latex wt. % achieved load values on the present apparatus of less than 800 g.

More specifically, an apparatus is provided for determining durability of a test sample of wallboard joint compound composition. The apparatus includes an adhesion release testing machine including a machine base, a mast connected to the base to extend vertically therefrom, a load cell connected to the mast, a sled movable on the machine base between a first position and a second position, and a display associated with the machine base and connected to the load cell for displaying numerical values of loads applied to the load cell. Also included is a probe plate including a lower surface from which depends a probe; an anchor base disposed on an upper surface of the probe plate; and a chain connecting the probe plate to the load cell. A set sample strip of wallboard joint compound composition is secured to an upper surface of the sled and arranged for engagement by the probe as the sled moves on the machine based between the first position and the second position.

In an embodiment, the probe plate is made of two layers of galvanized steel welded together, and having a hole, the probe is inserted into and fixed in the probe plate hole to depend from a lower surface of the plate. Preferably, the probe protrudes or depends 4 mm from the lower surface of the plate.

In an embodiment, the probe plate has an upper layer of resilient, rubber-like material for enhancing frictional engagement with the anchor base. Also, the anchor base has an upper base surface configured for accommodating a weight receptacle so that a weight exerted by the probe plate upon the sample is adjustable. In a preferred embodiment, the testing machine is a ChemInstruments AR 200 adhesion release testing machine.

In another embodiment, a method of testing durability of a gypsum wallboard joint compound composition includes: preparing a sample strip of set sample of the wallboard joint compound composition; providing an adhesion release testing machine including a machine base, a mast connected to the base to extend vertically therefrom, a load cell connected to the mast, a sled movable on the machine base between a first position and a second position, and a display associated with the machine base and connected to the load cell for displaying numerical values of loads applied to the load cell; providing a probe plate including a lower surface from which depends a probe; providing an anchor base disposed on an upper surface of the probe plate; connecting the anchor base to the load cell using a chain; securing the sample strip to an upper surface of the sled for engagement by the probe as the sled moves on the machine base between the first position and the second position.

In an embodiment, the method includes displaying on the display a load value generated by resistance generated by said probe engaging the sample strip and measured by the load cell.

In an embodiment, the sample strip is made of a composition in including latex having a weight percentage in the range of 2.9 to 9.4%.

In yet another embodiment, an aqueous wallboard joint compound composition is provided, comprising carbonate, Perlite, thickener, starch, biocide, water and latex, wherein the composition when set generates a drag force less than 800 g, and wherein the drag force is measured using the apparatus described above.

### BRIEF DESCRIPTION OF THE DRAWINGS

FIG. 1 is a top perspective view of the present test apparatus;

FIG. 2 is a fragmentary enlargement of the digital display of the apparatus of FIG. 1;

FIG. 3 is an enlarged top perspective view of the test probe apparatus as assembled;

FIG. 4 is bottom perspective view of the present probe;

FIG. 5 is a top plan view of the present probe;

FIG. 6 is a fragmentary side elevation of the test apparatus of FIG. 1 in a first position;

FIG. 7 is a fragmentary top perspective elevation of the test apparatus of FIG. 1 in a second position′ and

FIG. 8 shows samples tested using the present method; and

FIG. 9 is a graph of a comparison of amounts of latex in joint compound compared with drag force.

### DETAILED DESCRIPTION

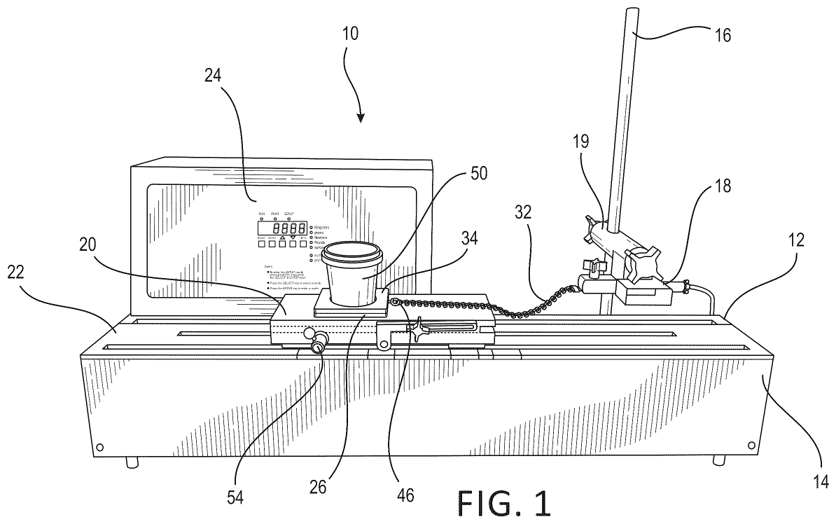

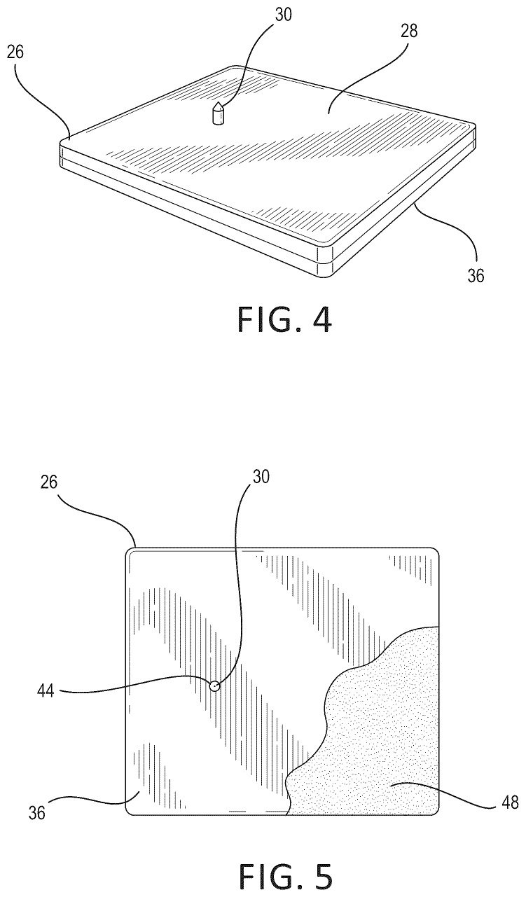

Referring now to FIGS. 1-5, the present drag force indicator apparatus for determining durability of a test sample of wallboard joint compound composition is generally designated 10 and is largely based on a conventional adhesion release testing machine 12, suitable examples are sold by ChemInstruments of Fairfield, Ohio under model designation Adhesion/Release Testing Machine (AR 200) (www.cheminstruments.com). The machine 12 is designed primarily for determining adhesion and release values of adhesion laminates at various speeds and at various angles of separation, and is modified as discussed below for the present application.

Included in the machine 12 is a machine base 14, a post-like mast 16 connected to the base to extend vertically therefrom, and a load cell 18 connected to the mast using a suitable clamp 19. A sled or test platform 20 is movable on the machine base 14 between a first position, where the sled is positioned approximately centrally on the machine base, and a second position where the sled is positioned closer to a display end 22 of the machine base. A display 24 is associated with the machine base 14 and is connected to the load cell 18 for displaying numerical values of loads applied to the load cell. Enclosed at least within the machine base 14 and the display 24 are software and electronic components (not shown, but well known in the art) designed to convert pulling force or load sensed by the load cell 18 to numerical values, preferably grams of force or the like.

Referring now to FIGS. 1, 3, 4, 5 and 6, modifications to the conventional adhesion release testing machine 12 include a probe plate 26 including a lower surface 28 from which depends a rigid, pin-like probe 30. A chain 32 connects an anchor base 34 to the load cell 18. Preferably, the probe plate 26 is adhered to the anchor base 34 using adhesive tape, adhesive or the like.

In the present application, the chain 32 is preferably a conventional linked metal chain, however it will be understood that in the present application “chain” will refer to any rigid power transmissive connector, including a wire or other types of connectors that transfer power, including but not limited to linked connectors. The anchor base 34 is disposed on, and preferably secured to an upper surface 36 of the probe plate 26, which is the reverse of the lower surface 28 from which the probe 30 projects, or depends, when in operational position. A set sample strip 38 of wallboard joint compound composition is secured to an upper surface 40 of the sled 20 and arranged for engagement by the probe 30 as the sled moves on the machine base 14 between the first position and the second position.

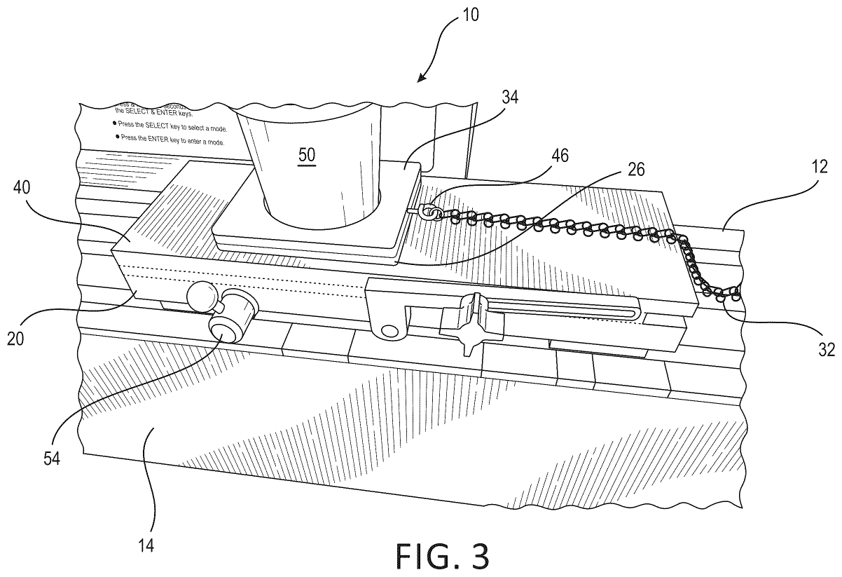

Referring now to FIGS. 3-5, in a preferred embodiment, the probe plate 26 is made of two layers 42 of galvanized steel welded together, preferably using copper, however other materials are contemplated. Also, the probe plate 26 is provided with a hole 44 into which the probe 30 is inserted and affixed, as by welding, chemical adhesive or the like to project, or to depend when the plate is operational, from the lower surface 28 of the plate 26. While other dimensions are contemplated, depending on the application, the probe 30 extends 4 mm from the lower surface 28, and the probe plate 26 is 4 inches (10 cm)×3.5 inches (8.75 cm). An eyelet 46 is optionally secured to one end of the anchor base 34 for connection of the chain 32.

To enhance frictional adherence between the probe plate 26 and the anchor base 34, the upper surface 36 of the probe plate 26 is preferably provided with a layer of resilient, rubber-like material 48 secured in place, as by chemical adhesive or the like.

Referring now to FIG. 3, the anchor base 34 is configured for accommodating a weight receptacle 50 so that a weight exerted by the probe 28 upon the sample strip 36 is adjustable. While other configurations are contemplated, in a preferred embodiment, the weight receptacle 50 is cup-shaped and the anchor base 34 includes a complementary recess for receiving the receptacle 50.

Preparation of the sample strip 36 is preferably achieved by safely cutting a piece of wallboard to measure 12 inches (30 cm) by 4 inches (10 cm). Next, the wallboard piece is placed on a clipboard or other hard, smooth surface so that the 4-inch side is located at a top end. Two planar strips or pieces of Plexiglas® clear acrylic sheets are then placed in spaced, parallel orientation on top of a face side of the wallboard piece, along the long edges, and all three are clamped together using the clipboard, in a position that allows for a 2-2.5-inch (5-6.25 cm) strip in the space between the strips of Plexiglas® clear acrylic sheets through a middle of the wallboard sample.

The designated joint compound composition to be tested is mixed, and applied to open area between the two spaced pieces of Plexiglas® clear acrylic sheets, which is filled completely to create the sample 38. Using a suitable drywall knife or trowel, extra compound is screed off to create a smooth surface of material flush with the Plexiglas® clear acrylic sheets. Multiple passes of the drywall knife may be required. Next, the sample 38 is unclipped, the Plexiglas® clear acrylic sheets pieces are carefully removed from the sides, then the sample is removed from the clipboard and allowed to completely dry and/or set, depending upon the type of composition being tested. The sample 38 will likely have raised edges from pulling the Plexiglas® clear acrylic sheets up off the board while the compound was wet—these raised edges are preferably scraped down with the drywall knife so that the edges are flush with the rest of the compound before testing.

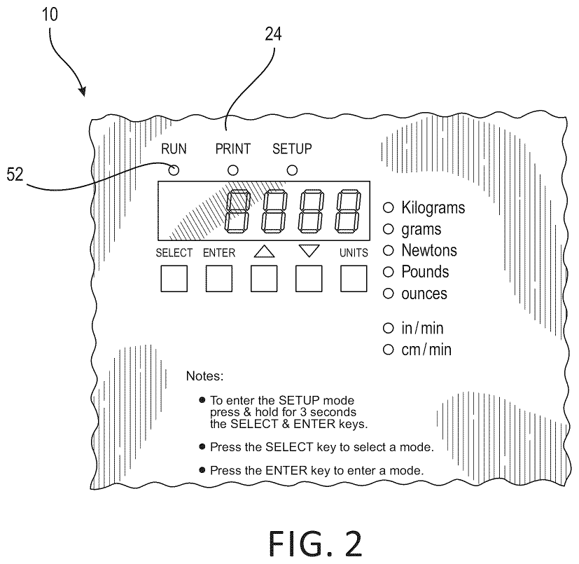

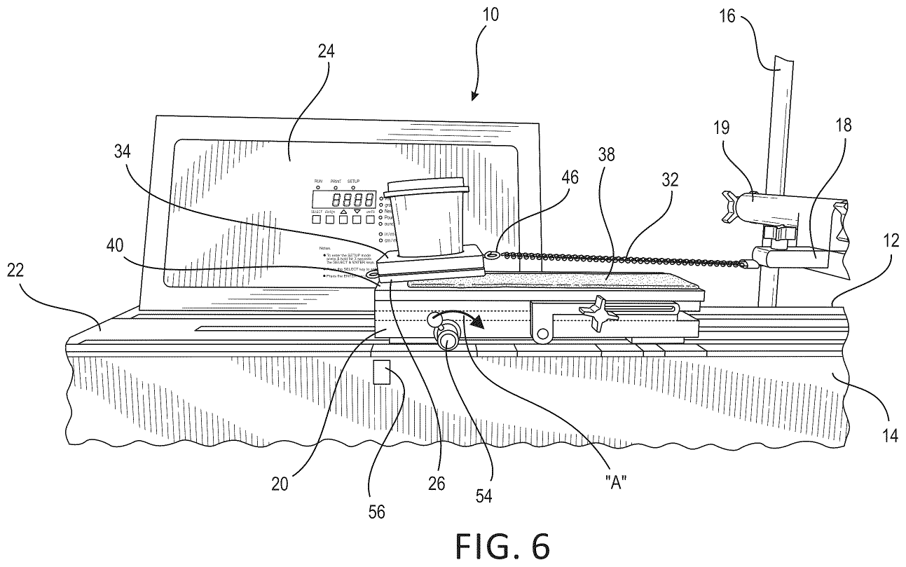

As seen in FIGS. 2 and 6, once the sample 38 is in place on the machine 12, an operator turns the machine power on and sets the pulling force or speed to be 601 inches/per minute, and an average “A” for obtaining an average of pull. A red light 52 under “RUN” on the display 24 should be illuminated. The anchor base 34 is preferably taped to the upper surface 36 of the probe plate 26 using double-sided tape or the like. Next, the sample 38 is secured to the upper surface 40 of the sled 20, preferably using double-sided tape or the like. A lever 52 on the side of the sled is maintained in the left position as seen in FIGS. 1 and 3. The sled 20 is positioned on the machine 12 so that a left side 54 is positioned at a designated “align” position 56 (FIG. 6), as indicated by a label, tape, marker or the like. This “align” position is considered the first position of the sled 20.

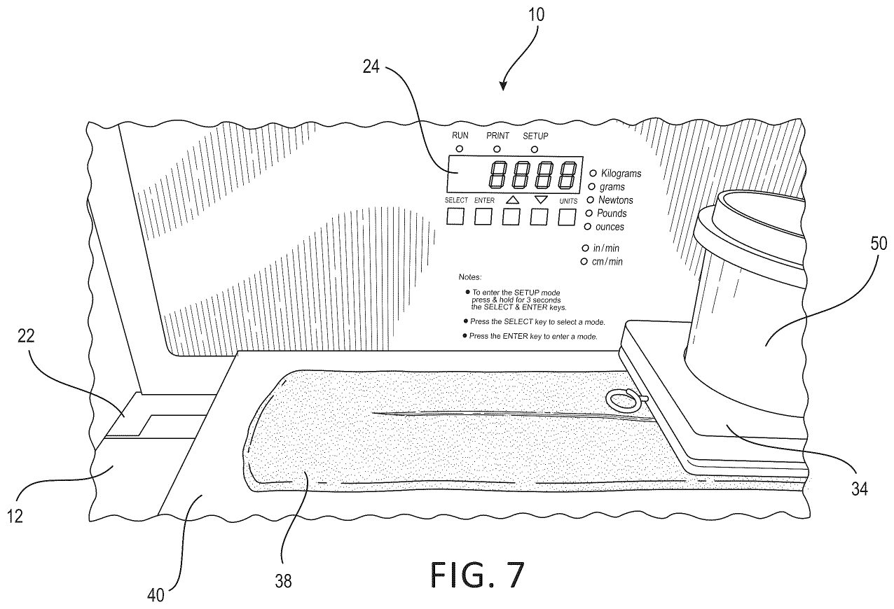

Referring now to FIGS. 6 and 7, the probe plate 26 is also pulled from the load cell direction and lightly placed and aligned on the sample 38 at the left edge of the sled 20, as seen in FIG. 6. Depending on the application and the composition of the sample 38, the operator may opt to add weight into the weight receptacle 50, which adds to the downward force applied by the probe 30 into the sample 38. With no weight in the weight receptacle 50, the downward force of the receptacle, the anchor base 34 and the probe plate 26 with the probe 30 totals 663 grams, which is contemplated as varying with the application and selection of materials. In the present application, the preferred drag force measured by the machine 12 is less than 800 grams.

When the test is set to begin, the operator turns the lever 52 on the sled 20 to the right in the direction of the arrow “A” in FIG. 6, which operates the machine 12, and moves the sled 20 automatically to the left to reach the second position, where the sled is closer to the display end 22 of the machine base 14, and farther from the load cell 18 (shown in FIG. 7). At this point, the display 24 will indicate a value for the pulling or drag force experienced by the probe pin 30 as it engaged the sample 38, and as measured by the load cell 18. At the completion of the test, the lever 52 is returned to the left position, and the probe plate 26 and the sample 38 are carefully removed from the sled 20. A drywall knife or trowel is needed to remover the sample 38 in some cases. Lastly, the machine 12 is powered down.

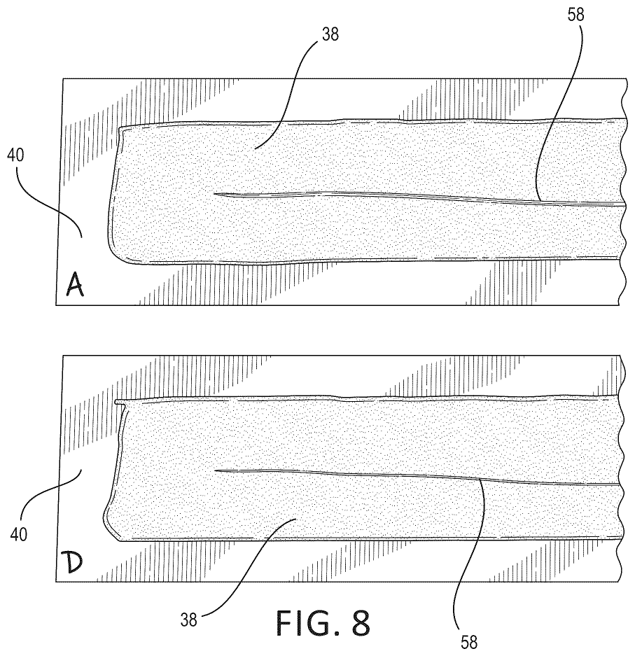

Referring now to FIGS. 7 and 8, depending on the hardness of the particular wallboard joint compound being tested as the sample 38, the probe 30 will experience varying degrees of drag or resistance. In other words, the harder or more durable is the sample 38, the less drag force or resistance experienced by the probe 30. Further, the softer the composition of the sample 38, the more apt it will be to be gouged or damaged by the probe 30. Comparison of the samples 38 having various compositions includes an evaluation of a gouge or groove 58 formed by the movement of the sled 20 relative to the probe plate 26. In the present application, the preferred drag force measured by the machine 12 and displayed on the display 24 is less than 800 grams, which indicates a relatively durable wallboard joint compound composition used as the sample 38.

In FIG. 8, sample A shows a relatively deep gouge 58, indicating a softer, less durable sample composition 38. In contrast, sample D shows a shallower, less damaging groove 58, indicating a more durable sample composition 38. In the latter example, the drag force measured by the machine 12 will be lower than that measured for sample A.

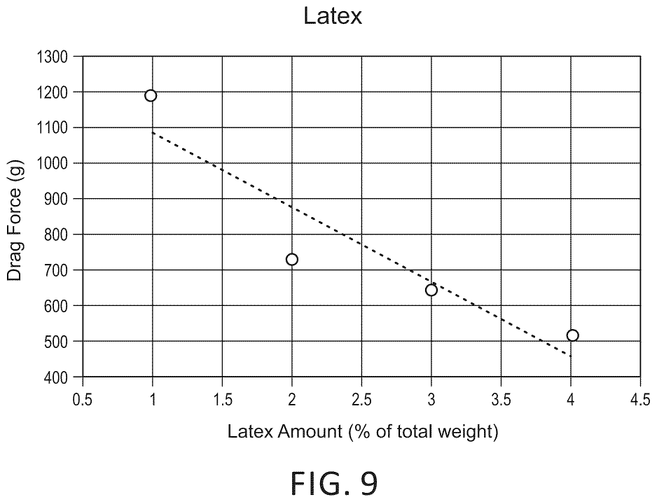

Referring now to FIG. 9 and Tables 1-4, various wallboard joint compound compositions were evaluated using the present apparatus 10, including the machine 12 as described above. As is known in the art, the composition of wallboard joint compound varies by application, but common constituents include a base of calcium carbonate, binders, and fillers. If the wallboard joint compound is of the ready-mix type, a significant amount of water is included to render the composition usable from the shipping container. Through use of the present apparatus 10, it was surprisingly found that compositions having increased weight percentages of latex were more durable, when the amounts of the other constituents were held constant.

In Table 1, it is seen that the sample composition 38 had no latex, and use if the machine 12 as described above resulted in a pulling or drag force of 1194 grams. In Table 2, the sample composition 38 included 22 g of latex or a weight percentage of 2.93%, and the resulting drag force was 732 grams. Next, in Table 3, the latex was 46 g or 6.06 wt. %, and the drag force was 646 grams. Lastly, in Table 4, the latex was increased to 76 g or 9.44 wt. %, and the measured drag force was 520 grams. FIG. 9 is a plot of these four tests which compare Drag Force in grams against weight percentage of latex. The data shows that when the sample 38 is made of a composition including latex having a weight percentage in the range of 2.9 to 9.4%, the drag force is less than 800 grams.

TABLE 1

| Ingredient | g | % of total |
|---|---|---|
| Carbonate | 230 | 31.56% |
| Attapulgite | 13 | 1.71% |
| Kaolin | 13 | 1.71% |
| Coated Perlite | 76.8 | 10.56% |
| Cellulosic Thickener | 4.0 | 0.55% |
| Starch | 1.3 | 0.17% |
| Latex | 0 | 0.00% |
| Biocide | 1.6 | 0.22% |
| Water | 390 | 53.51% |
| Total Weight | 729 | 100.00% |
| Drag force | 1194 | |

TABLE 2

| Ingredient | g | % of total |
|---|---|---|
| Carbonate | 230 | 30.63% |
| Attapulgite | 13 | 1.66% |
| Kaolin | 13 | 1.66% |
| Coated Perlite | 76.8 | 10.25% |
| Cellulosic Thickener | 4.0 | 0.53% |
| Starch | 1.3 | 0.17% |
| Latex | 22 | 2.93% |
| Biocide | 1.6 | 0.22% |
| Water | 390 | 51.94% |
| Total Weight | 751 | 100.00% |
| Drag force | 732 | |

TABLE 3

| Ingredient | g | % of total |
|---|---|---|
| Carbonate | 230 | 29.64% |
| Attapulgite | 13 | 1.61% |
| Kaolin | 13 | 1.61% |
| Coated Perlite | 76.8 | 9.93% |
| Cellulosic Thickener | 4.0 | 0.52% |
| Starch | 1.3 | 0.16% |
| Latex | 47 | 6.06% |
| Biocide | 1.6 | 0.21% |
| Water | 390 | 50.27% |
| Total Weight | 776 | 100.00% |
| Drag force | 646 | |

TABLE 4

| Ingredient | g | % of total |
|---|---|---|
| Carbonate | 230 | 28.58% |
| Attapulgite | 13 | 1.55% |
| Kaolin | 13 | 1.55% |
| Coated Perlite | 76.8 | 9.57% |
| Cellulosic Thickener | 4.0 | 0.50% |
| Starch | 1.3 | 0.16% |
| Latex | 76 | 9.44% |
| Biocide | 1.6 | 0.20% |
| Water | 390 | 48.45% |
| Total Weight | 805 | 100.00% |
| Drag force | 520 | |

While a particular embodiment of the present drag force indicator has been described herein, it will be appreciated by those skilled in the art that changes and modifications may be made thereto without departing from the invention in its broader aspects and as set forth in the following claims.

1. An apparatus for determining durability of a test sample of wallboard joint compound composition, comprising:
an adhesion release testing machine including a machine base, a mast connected to the base to extend vertically therefrom, a load cell connected to the mast, a sled movable on the machine base between a first position and a second position, and a display associated with the machine base and connected to the load cell for displaying numerical values of loads applied to the load cell;
a probe plate including a lower surface from which depends a probe;
an anchor base disposed on an upper surface of said probe plate;
a chain connecting said anchor base to the load cell;
a set sample strip of wallboard joint compound composition secured to an upper surface of the sled and arranged for engagement by said probe as the sled moves on the machine based between the first position and the second position.

2. The apparatus of claim 1, wherein said probe plate is made of two layers of galvanized steel welded together, and having a hole, said probe is inserted into and fixed in said probe plate hole to depend from a lower surface of said plate.

3. The apparatus of claim 2, wherein said probe depends 4 mm from said lower surface of said plate.

4. The apparatus of claim 2, wherein said probe plate has an upper layer of resilient, rubber-like material for enhancing frictional engagement with said anchor base.

5. The apparatus of claim 1, wherein said anchor base has an upper base surface configured for accommodating a weight receptacle so that a weight exerted by said probe plate upon said sample is adjustable.

6. The apparatus of claim 1, wherein the adhesion release testing machine is a ChemInstruments AR 200.

7. A method of testing durability of a gypsum wallboard joint compound composition, comprising:
preparing a sample strip of set sample of the wallboard joint compound composition;
providing an adhesion release testing machine including a machine base, a mast connected to the base to extend vertically therefrom, a load cell connected to the mast, a sled movable on the machine base between a first position and a second position, and a display associated with the machine base and connected to the load cell for displaying numerical values of loads applied to the load cell;
providing a probe plate including a lower surface from which depends a probe;
providing an anchor base disposed on an upper surface of said probe plate;
connecting said anchor base to the load cell using a chain;
securing said sample strip to an upper surface of the sled for engagement by said probe as the sled moves on the machine base between the first position and the second position.

8. The method of claim 7, further including displaying on said display a load value generated by resistance generated by said probe engaging said sample strip and measured by the load cell.

9. The method of claim 7, wherein said sample strip is made of a composition including latex having a weight percentage in the range of 2.9 to 9.4%.

10. An aqueous wallboard joint compound composition, comprising carbonate, Perlite, thickener, starch biocide water and latex, wherein the composition when set generates a drag force less than 800 g, wherein said drag force is measured using the apparatus of claim 1.
